(19) United States
(12) Patent Application Publication
(10) Pub. No.: US 2009/0220834 A1
(43) Pub. Date: Sep. 3, 2009

(54) MEMBRANE-ELECTRODE ASSEMBLY HAVING A MULTICOMPONENT SEALING RIM

(75) Inventors: Klaus Schaack, Obernburg (DE); Lutz Rohland, Hanau (DE)

Correspondence Address: SMITH, GAMBRELL & RUSSELL, SUITE 3100, PROMENADE II, 1230 PEACHTREE STREET, N.E., ATLANTA, GA, 30309-3592, US

(73) Assignee: UMICORE AG & CO., KG, HANAU-WOLFGANG (DE)

(21) Appl. No.: 12/162,795

(22) PCT Filed: Feb. 1, 2007
(86) PCT No.: PCT/EP07/00853

§ 371 Date: Oct. 14, 2008

(30) Foreign Application Priority Data
Feb. 2, 2006 (DE) 10-2006-004748.6

(51) Int. Cl. H01M 4/86; C25B 13/00; B32B 7/04; B29C 45/16; H01M 8/10; B29C 45/14

(52) U.S. Cl. 429/30; 204/282; 156/91; 264/241; 204/421

(57) ABSTRACT

The invention relates to a membrane-electrode assembly having a multicomponent sealing rim, with the rim components being joined by means of two different joining methods. The rim construction of the membrane-electrode assembly comprises at least two materials (sealing material A and frame B) which are joined to one another both by adhesion and by physical locking. The frame B has at least one perforation through which the sealing material penetrates and establishes an intermeshing connection. Adhesive bonding methods, lamination processes and/or injection moulding processes are suitable for producing the multicomponent rim and the corresponding membrane-electrode assembly. The multicomponent rim construction has a high bond strength. The membrane-electrode assembly having a multicomponent rim is used in electrochemical devices such as fuel cells (PEMFCs, DMFCs, etc.), electrolysers or electrochemical sensors.

The invention relates to a membrane-electrode assembly (“MEA”) having a multicomponent sealing rim, and also a process for producing it. The at least two rim components are joined by means of two different joining methods. The membrane-electrode assembly is used in electrochemical devices such as fuel cells (membrane fuel cells, PEMFCs, DMFCs, etc.), electrolysers or electrochemical sensors. The rim construction has a high adhesive strength.

Fuel cells convert a fuel and an oxidant at separate locations at two electrodes into electric power, heat and water. As fuel, it is possible to employ hydrogen or a hydrogen-rich gas, while oxygen or air can serve as oxidant. The process of energy conversion in the fuel cell has a particularly high efficiency. For this reason, fuel cells are becoming increasingly important for mobile, stationary and portable applications.

For the purposes of the present invention, a PEM fuel cell stack is a stacked arrangement (“stack”) of fuel cell units. A fuel cell unit will hereinafter also be referred to as a fuel cell for short. It comprises in each case a membrane-electrode assembly which is arranged between bipolar plates, which are also referred to as separator plates and serve for supply of gas and conduction of electricity.

The key element of the PEM/DMFC fuel cell is the membrane-electrode assembly (“MEA”). The membrane-electrode assembly has a sandwich-like structure and generally consists of five layers. To produce a five-layer membrane-electrode assembly, the anode gas diffusion layer (anode “GDL”) and the corresponding anode catalyst layer are joined or laminated on the front side, the cathode gas diffusion layer and the corresponding cathode catalyst layer are joined or laminated on the rear side to the ionomer membrane in the middle in a sandwich-like fashion. Sealing can be effected by means of a suitable sealing material.

In the production of the MEA, the catalyst layers are, in general, firstly applied to the gas diffusion layers. The gas diffusion electrodes (“GDEs”) so produced are then attached to the front or rear side of an ionomer membrane (“CCB process”). The sealing material is subsequently applied around the edge.

Membrane-electrode assemblies having a simple sealing rim are known from the prior art.

DE 197 03 214 discloses a membrane-electrode assembly having an integrated sealing rim, with the membrane being completely covered by the electrodes and the sealing rim being joined by adhesion to electrodes and membrane.

WO 2000/10216 describes a membrane-electrode assembly having a multicomponent sealing rim, with different materials being joined to one another by adhesion.

WO 2005/006473 discloses a membrane-electrode assembly which has a semi-coextensive design, i.e. has different-sized gas diffusion layers on front and rear side. The edge of the membrane-electrode assembly is surrounded by a sealing material. Membrane-electrode assemblies having a multicomponent rim and ones having an additional exterior frame are described. In all these cases, the rim components are joined to one another by adhesion. A combined joining method is not disclosed.

A disadvantage of the known membrane-electrode assemblies having a multicomponent rim is the lack of strength of the bond between the rim components. Materials which do not form a good adhesive bond to one another (e.g. owing to a lack of wetting and/or poor adhesive action) display poor adhesion in the composite.

In addition, the constructions known hitherto display unsatisfactory stability in long-term operation of the fuel cell because of the tendency of the rim components to undergo creep.

It was therefore an object of the present invention to provide a membrane-electrode assembly having an improved multicomponent rim. The rim according to the invention should, for example, have a higher adhesive strength, better sealing properties, a low tendency to undergo creep and a higher long-term stability. At the same time, a process for producing such a membrane-electrode assembly having a multicomponent rim is to be provided. Here, very different frame materials should be able to be joined to one another with improved bonding strength.

This object is achieved by provision of a membrane-electrode assembly according to claim 1. Further claims relate to advantageous embodiments and to the processes for producing the membrane-electrode assembly of the invention.

The invention describes a membrane-electrode assembly having a multicomponent sealing rim in which at least two rim components are joined to one another both by adhesion and by physical locking. Thus, two joining methods (adhesion and physical locking) are used for joining the at least two rim components. The adhesive connection can generally be effected by adhesives technology, while the connection by physical locking can, for example, be effected by means of additional intermeshing of the at least two components.

This combined use of two joining methods results in a higher strength, in particular a higher tensile strength, of the sealing rim compared to conventional rims which have only an adhesive connection. The rim structure according to the invention offers the further advantage that a broader selection of materials is available for the rim components. In particular, stronger materials having low creep properties can be used for the frame (component B). Furthermore, the present invention offers the advantage that a strong bond can be achieved between mechanically stable frame materials (component B) and softer sealing materials (component A) which usually do not give ideal adhesion on being joined to one another.

The joining process according to the invention with combined adhesion and physical locking thus enables a considerably greater number of material combinations and variation opportunities in MEA production.

For the purposes of the present invention, it is irrelevant whether the generally five-layer membrane-electrode assembly itself is constructed according to a coextensive or semi-coextensive design or whether it has a projecting membrane area. The improvement over conventional rim constructions is independent of the MEA design.

The combined adhesion and physical locking connection can occur either between the various rim components or between the MEA components and the rim components. Combinations of these alternatives are also possible.

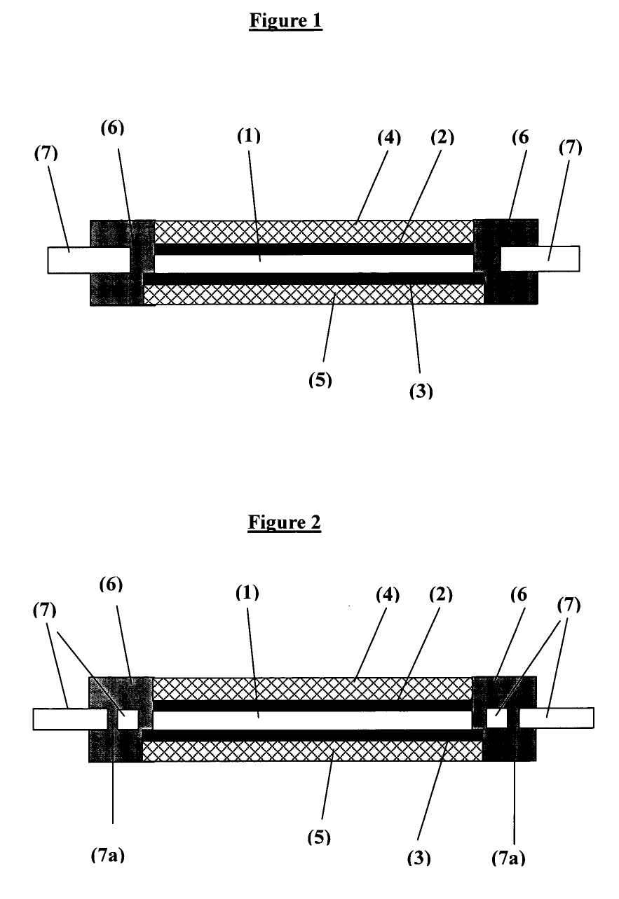

FIG. 1 shows the structure of a conventional membrane-electrode assembly which has a two-component rim in which the components are joined to one other only by adhesion. The five-layer membrane-electrode assembly has a semi-coextensive design and comprises an ionomer membrane (1) to whose front side the catalyst layer (2) has been applied and to whose rear side the catalyst layer (3) has been applied. On top of this, the gas diffusion layer (4) is present on the front side and the gas diffusion layer (5) is present on the rear side of the membrane. The periphery of the membrane-electrode assembly is surrounded by sealing material (6). A frame (7) is embedded in this sealing material and is joined by adhesion to the sealing material (6). This gives a two-component rim comprising sealing material (6) and frame (7).

FIG. 2 shows by way of example the structure of a membrane-electrode assembly according to the invention which has a rim in which two components are joined to one another by both adhesion and by physical locking. The five-layer membrane-electrode unit has a semi-coextensive design and has an ionomer membrane (1) with the catalyst layers (2) and (3) and the gas diffusion layers (4) and (5). The periphery of the membrane-electrode assembly is surrounded by sealing material (6). A frame (7) which has at least one perforation or through-passage (7a) is inserted in this sealing material. The frame (7) is joined to the sealing material by adhesion and physical locking. The sealing material (6) (“component A”) penetrates in the liquid or plastic state through the frame (7) (“component B”) at the perforated place or places and forms an intermeshing, physically locking connection with the frame (7) after curing or cooling. The shape, number and positioning of the individual perforations (or openings, holes or through-passages) in the frame (7) depend on the individual structural requirements and can be matched to the MEA design. At least one perforation (7a) should be provided in the frame (7).

The invention provides a membrane-electrode assembly which has a multicomponent rim in which, in a preferred embodiment, the frame (7) in the exterior region has a thickness which is lower than that of the total membrane-electrode assembly. The membrane-electrode assembly of the invention is therefore particularly suitable for use in compact PEM stacks having a high power density, e.g. for mobile fuel cell applications.

In a further embodiment, the frame (7) in the exterior region has a thickness which is the same or higher than that of the total membrane-electrode assembly.

The rim construction according to the invention is particularly suitable for MEA production using known mass production methods, for example injection moulding or lamination processes.

Connecting and joining techniques can in principle be divided into three physical mechanisms: force-transmitting connection, physical locking connection and adhesive connection (adhesion).

Force-transmitting connections are produced by the transmission of forces. These include, for example, pressure forces or frictional forces. The force-transmitting connection is held together only by the force which acts in the connection.

Physically locking connections are produced by the intermeshing of at least two components of the join. As a result of the mechanical connection, the components of the join cannot come apart even without transmission of force or when the transmission of force is interrupted. Examples are the claw coupling and the gear wheel.

Adhesive connections are all connections in which the components of the join are held together by atomic or molecular forces. Adhesive connections are produced, for example, by adhesive bonding, soldering and welding.

The individual components of the membrane-electrode assembly of the invention having a multicomponent rim are described below.

The ionomer membrane preferably contains proton-conducting polymer materials. These materials will hereinafter also be referred to as ionomers for short. Preference is given to using a tetrafluorethylene-fluorovinyl ether copolymer having sulphonic acid groups. This material is, for example, marketed under the trade name Nafion® by DuPont. However, it is also possible to use other, in particular fluorine-free, ionomer materials such as doped sulphonated polyether ketones, doped sulphonated or sulphinated alkyl ketones, doped polybenzimidazoles and mixtures thereof.

As electro-catalysts (anode and cathode catalysts), preference is given to using precious metals, in particular the metals of the platinum group of the Periodic Table of Elements. Use is most often made of supported catalysts in which the catalytically active platinum group metals (e.g. Pt and/or Pt/Ru) have been deposited in highly dispersed form to the surface of a conductive support material (e.g. carbon black or graphite).

The gas diffusion layers (“GDLs”) can comprise porous, electrically conductive materials such as carbon fibre paper, carbon fibre nonwoven, woven carbon fibre fabrics, metal meshes, metallized woven fibre fabrics and the like. They can be hydrophobicized and/or have a microporous layer (“microlayer”).

As sealing material (6) (component A) for sealing the membrane-electrode assembly, it is possible to use organic polymers which are inert under the operating conditions of the fuel cell and do not release any interfering substances. The polymers have to be able to wet the gas diffusion layers and to seal or enclose them in a gas-tight manner. Further important requirements such polymers have to meet are good adhesion and good wetting properties towards the free surface of the ion-conducting membrane. Suitable materials are thermoplastic polymers such as polyethylene, polypropylene, PTFE, PVDF, polyamide, polyimide, polyurethane or polyester; also thermoset polymers such as epoxy resins or cyanoacrylates. Further suitable polymers are elastomers such as silicone rubber, EPDM, fluororubbers, perfluororubbers, chloroprene rubbers, fluorosilicone elastomers. The sealing material (component A) can be used in the form of sheets, films or preforms, in the form of adhesives, pastes or inks or in the form of granules or pulverulent preparations (for example for injection moulding applications).

As material for the frame (7) (component B), it is possible to use, in particular, creep-resistant materials such as polymers having a glass transition temperature (Tg) above 100° C., preferably above 120° C. Preference is also given to polymers having a high melting point and/or a high heat distortion resistance. Examples of such materials are thermally stable polymer materials such as polyester, polyphenylene sulphides, polyimides, glass fibre-reinforced plastics, polytetrafluoroethylene (PTFE), special polyamides as well as high-melting polymers in general. In general, the frame material is used in the form of sheets, tapes or films having a thickness in the range from 0.01 to 1 mm, preferably in the range from 0.05 to 0.5 mm.

The desired at least one perforation (through-passage or hole) is introduced into the frame (7) before installation. This can be effected, for example, by stamping, cutting, waterjet cutting, ultrasonic cutting, laser cutting, milling, drilling or etching. The perforation can have any shape, with geometrically simple shapes (e.g. round, triangular, rectangular or oval shapes) being preferred because they are quicker and more efficient to manufacture. The internal diameter of the perforation is in the range from 0.1 to 100 mm, preferably in the range from 0.5 to 50 mm. However, the frame can also have at least one elongated, slit-like perforation.

If a plurality of perforations are provided, the typical distances between them are in the range from 0.1 to 100 mm, preferably in the range from 0.5 to 50 mm. The number and size of the perforations in the frame (7) depend on the required strength of the adhesive connection between the individual components. The weaker the adhesion is, the stronger should the physically locking connection be made. Since, for example, polyamide (sealing material A) forms only a weak bond to polyester (frame B) on cooling from the melt, additional physical locking is necessary to increase the strength of the connection (cf. Example 1).

To produce the membrane-electrode assemblies having a multicomponent rim, the MEA components are joined to the at least two rim components by means of conventional methods. In a multistage process, the production of the five-layer MEA, i.e. joining of ionomer membrane (1), catalyst layers (2, 3) and gas diffusion layers (4, 5) can firstly be carried out separately, for example by lamination processes. In one or more further steps, the rim is then produced.

However, the MEA components can also be joined to one another in a single step together with production of the rim. This is particularly advantageous in the case of continuous processes.

However, the multicomponent rim can also be produced subsequently, in which case, for example, a frame B is added to an existing seal.

It is in principle possible to use, for example, adhesive bonding methods (depending on the adhesives used, either at room temperature or at elevated temperature), lamination processes (generally at elevated temperature and under pressure application) or injection moulding processes for joining the MEA components and rim components. Other methods are also possible as long as they produce the combined adhesive and physically locking connection of the rim components. Lamination processes generally use special pressing tools and pressing moulds, and suitable temperatures are in the range from 50 to 200° C., with pressing pressures being in the range from 10 to 100 N/mm².

The process steps described are, when appropriately adapted or modified, also suitable for continuous manufacturing processes for membrane-electrode assemblies.

The following examples illustrate the invention without restricting its scope.

### EXAMPLE 1

To produce a product according to the invention, a membrane-electrode assembly is firstly provided. This MEA comprises the following components:

a) Cathode electrode (cathode CCB): basis Sigracet, hydrophobicized, with microlayer; from SGL Meitingen; precious metal loading: 0.5 mg Pt/cm²; platinum catalyst: 60% platinum on carbon black.

b) Anode electrode (anode CCB): basis Sigracet, hydrophobicized, with microlayer, from SGL Meitingen; precious metal loading: 0.3 mg Pt/cm²; platinum catalyst: 60% platinum on carbon black.

c) Polymer electrolyte membrane: Nafion® NR 111, protonated form (from DuPont).

These three components are placed together and laminated in a hot press to produce a five-layer membrane-electrode assembly. The pressing step takes place at 150° C. and requires a specific pressure of 150 N/cm².

The semi-coextensive MEA design is used in the present example. Here, the square anode has external dimensions of 5.4×5.4 cm², and cathode and membrane are stamped out to the dimensions 6×6 cm². This gives a peripheral step having a width of 0.3 cm, so that an area of uncovered membrane is present around the anode and extends around the entire periphery of the arrangement.

In the next step, the membrane-electrode assembly described is provided with a multicomponent rim which enables the installation in the fuel cell stack and the sealing of the stack.

It is produced using a pressing tool which comprises pressing plates with ventilation holes and templates which enclose an interior recess. The membrane-electrode assembly is laid in this recess together with two polyamide film windows (Vestamelt®, Degussa, Duesseldorf) so that the films enclose the MEA. A frame (6) projects into the peripheral regions of the polyamide film window so that its inner regions are located between the polyamide films but its outer regions project out beyond the dimensions of the polyamide films.

The frame (6) which projects out consists of a stamped polyester film (Hostaphan RN 190). For this purpose, 48 holes having diameters of 2 mm are stamped into the polyester frame so that the molten polyamide can penetrate through the polyester film during the lamination process. The perforated polyester frame in each case has external dimensions of 8×8 cm² and a thickness of 0.30 mm. The holes are spaced at 4 mm from one another.

The components are introduced into a specially manufactured pressing tool. This pressing mould is placed in a hot press and pressed at a heating surface temperature of 185° C. for 60 seconds. After cooling of the pressing mould, the membrane-electrode assembly is taken out.

Electrochemical measurements: Two specimens produced according to this process were installed in an electrochemical PEM single cell and tested under fully humidified conditions at 75° C./1.5 bar in hydrogen/air operation. A cell voltage of 720-730 mV at a current density of 600 mA/cm² is obtained.

### COMPARATIVE EXAMPLE

### CE1

The product is produced as described in the example above, however, a polyester frame without perforations (holes) is used, so that the rim components are joined only by adhesion.

The three components are once again placed together and laminated in a hot press to produce the MEA. The pressing step takes place at 150° C. and requires a specific pressure of 150 N/mm². All other process steps are identical to the example above.

### Tensile Strength Measurements

Using a method analogous to the joining of sealing material (6) and frame (7) in the membrane-electrode assembly of the invention, test strips having a purely adhesive connection (as in Comparative Example CE1) and with additional physical locking (as in Example 1 according to the invention) were produced. The strength of these test strips was examined in a tensile test. The tensile test was carried out using a universal testing machine model 5543 (from Instron) by a method based on DIN EN 1465 (“Determination of the tensile shear strength of high-strength overlapping adhesive bonds”). The tensile strength of the specimens was measured at two extension rates (v1=5 mm/min and v2=50 mm/min). The force required for rupture of the bond was recorded.

The results are summarized in Table 1. It can be seen that the rim construction according to the invention with adhesion and physical locking has a tensile shear strength which is by a factor of about 2 better than that of the conventional rim construction.

TABLE 1

| | Force in N | Force in N |
|---|---|---|
| Rim construction | v1 = 5 mm/min | v2 = 50 mm/min |
| Adhesion and physical locking | 290 | 340 |
| (Example 1) | | |
| Adhesion | 180 | 180 |
| (Comparative Example 1) | | |

1. Membrane-electrode assembly for electrochemical devices having a front side and a rear side, comprising an ionomer membrane, a gas diffusion layer and a catalyst layer on the front side, a gas diffusion layers and a catalyst layer on the rear side and a multicomponent rim, wherein the rim comprises at least one sealing material and at least one frame having at least one perforation and wherein the sealing material and the frame are joined to one another both by adhesion and by physical locking.

2. Membrane-electrode assembly according to claim 1, wherein the frame has an exterior region which has a lower thickness than the membrane-electrode assembly.

3. Membrane-electrode assembly according to claim 1, wherein the frame comprises a polymer material selected from the group consisting of polyesters, polyphenylene sulphides, polyimides, glassfibre-reinforced plastics, polytetrafluoroethylene (PTFE), polyamides and combinations thereof.

4. Membrane-electrode assembly according to claim 1, wherein the frame comprises a polymer material having a glass transition temperature (Tg) above 100° C.

5. Membrane-electrode assembly according to claim 1, wherein the sealing material comprises a thermoplastic polymer selected from the group consisting of polyethylene, polypropylene, PTFE, PVDF, polyamide, polyimide, polyurethane and polyester; or a thermoset polymer selected from the group consisting of epoxy resins and cyanoacrylates; or an elastomer selected from the group consisting of silicone rubber, EPDM, fluororubbers, perfluororubbers, chloroprene rubbers and fluorosilicone elastomers.

6. Membrane-electrode assembly according to claim 1, wherein the at least one perforation in the frame has an internal diameter in the range from 0.1 to 100 mm.

7. Membrane-electrode assembly according to claim 1, wherein the ionomer membrane contains a proton-conducting ionomer material selected from the group consisting of tetrafluoroethylene-fluorovinyl ether copolymers having sulphonic acid groups or a fluorine-free ionomer material selected from the group consisting of doped sulphonated polyether ketones, doped sulphonated or sulphinated aryl ketones, doped polybenzimidazoles and mixtures thereof.

8. Membrane-electrode assembly according to claim 1, wherein the gas diffusion layers comprise a porous, electrically conductive material selected from the group consisting of carbon fibre paper, carbon fibre nonwoven, woven carbon fibre fabrics, metal meshes and metalized woven fibre fabrics.

9. Process for producing a membrane-electrode assembly for electrochemical devices having a front side and a rear side, comprising an ionomer membrane, a gas diffusion layer and a catalyst layer on the front side, a gas diffusion layer and a catalyst layer on the rear side and also a multicomponent rim, wherein the rim comprises at least one sealing material and at least one frame having at least one perforation;
said process including joining the sealing material and the frame to one another both by adhesion and by physical locking.

10. Process according to claim 9, wherein joining of ionomer membrane, catalyst layers, gas diffusion layers, and also sealing material and frame is carried out in one step by means of adhesive bonding methods, lamination processes, injection moulding processes or combinations thereof.

11. Process according to claim 9, wherein the joining of ionomer membrane, catalyst layers, gas diffusion layers, and also sealing material and frame is carried out in various steps by means of adhesive bonding methods and/or lamination processes and/or injection moulding processes.

12. Process according to claim 11, wherein the joining of ionomer membrane, catalyst layers, and gas diffusion layers is carried out by means of a lamination process and the multicomponent rim is produced by a further lamination process.

13. Process according to claim 11, wherein the joining of ionomer membrane, catalyst layers and gas diffusion layers is carried out by means of a lamination process and the multicomponent rim is produced by an injection moulding process.

14. A membrane fuel cell comprising the membrane-electrode assembly according to claim 1.

15. Membrane-electrode assembly according to claim 1, wherein the frame comprises a polymer material having a glass transition temperature (Tg) above 120° C.

16. Membrane-electrode assembly according to claim 1, wherein at least one perforation in the frame has an internal diameter in the range from 0.5 to 50 mm.

17. An electrolyser comprising the membrane-electrode assembly according to claim 1.

18. An electrochemical sensor comprising the membrane-electrode assembly according to claim 1.
